(19) United States
(12) Patent Application Publication
(10) Pub. No.: US 2020/0328705 A1
(43) Pub. Date: Oct. 15, 2020

(54) POWER GENERATION SYSTEM AND METHOD OF OPERATING THE SAME

(71) Applicant: General Electric Company, Schenectady, NY (US)

(72) Inventors: Govardhan GANIREDDY, Bangalore (IN); Amol Rajaram KOLWALKAR, Bangalore (IN); Somakumar RAMACHANDRAPANICKER, Bangalore (IN); Arvind Kumar TIWARI, Bangalore (IN); Sharath Sridhar ARAMANEKOPPA, Bangalore (IN); Subbarao TATIKONDA, BAngalore (IN); Yashomani Y. KOLHATKAR, Bangalore (IN)

(21) Appl. No.: 16/303,712

(22) PCT Filed: Jun. 16, 2017
(86) PCT No.: PCT/US2017/037935

§ 371 Date: Nov. 21, 2018

(30) Foreign Application Priority Data
Jun. 17, 2016 (IN) 201641020905

(51) Int. Cl. H02P 9/00; H02J 3/46

(52) U.S. Cl. CPC H02P 9/007; H02J 3/46

(57) ABSTRACT

A power generation system is disclosed. The power generation system includes an engine coupled to a DFIG and a PV power source to supply a solar electrical power to the DFIG (108). The power generation system also includes a controller configured to operate the engine at a first operating speed corresponding to a first determined efficiency of the engine for a first desired level of an engine power in a first operating condition; or operate the engine at a second operating speed corresponding to a desired level of the second electrical power to be absorbed by a rotor winding and a second desired level of the engine power in a second operating condition, wherein the determined first efficiency is substantially close to a first maximum achievable efficiency of the engine. Method of operating the power generation system is also disclosed.

### BACKGROUND

The present application relates generally to generation of electrical power and more particularly relates to a power generation system employing an engine and a photo-voltaic (PV) power source.

Typically, power generation systems such as generators use fuels such as diesel, petrol, and the like to generate an electrical power that can be supplied to local electrical loads. Reducing consumption of the fuels is an ongoing effort in achieving low cost and environment friendly power generation systems. To that end, various hybrid power generation systems are available that use a generator operated by an engine as primary source of electricity and some form of renewable energy source such as a wind turbine as an auxiliary source of electricity. In such hybrid power generation systems, typically an amount of power generated by the renewable energy sources varies. Therefore there exists a need for a system for controlling the power generated by the generators and/or the power generated by the renewable energy sources.

### BRIEF DESCRIPTION

In accordance with an embodiment of the present specification, a power generation system is disclosed. The power generation system includes an engine operable at variable speeds. The power generation system further includes a doubly-fed induction generator (DFIG) mechanically coupled to the engine. The DFIG includes a generator having a rotor winding and a stator winding, a rotor side converter electrically coupled to the rotor winding, and a line side converter electrically coupled to the stator winding, wherein the generator is configured to generate a first electrical power at the stator winding and to generate or absorb a second electrical power at the rotor winding. Furthermore, the power generation system includes photo-voltaic power source electrically coupled to a direct-current (DC) link between the rotor side converter and the line side converter, wherein the photo-voltaic power source is configured to supply a solar electrical power to the DC-link. The power generation system also includes a controller operatively coupled to the engine, the rotor side converter, and the line side converter and configured to enable operation of the engine at a first operating speed corresponding to a first determined efficiency of the engine for a first desired level of an engine power in a first operating condition, wherein the first determined efficiency is substantially close to a maximum achievable efficiency of the engine. Alternatively, the controller is configured to enable operation of the engine at a second operating speed corresponding to a desired level of the second electrical power to be absorbed or generated at the rotor winding and a second desired level of the engine power in a second operating condition.

In accordance with an embodiment of the present specification, a method for operating the power generation system. The method includes enabling operation of the engine at a first operating speed corresponding to a first determined efficiency of the engine for a first desired level of an engine power in a first operating condition, wherein the first determined efficiency is substantially close to a maximum achievable efficiency of the engine, wherein the engine is mechanically coupled to a DFIG. The DFIG includes a generator having a rotor winding and a stator winding, a rotor side converter electrically coupled to the rotor winding, and a line side converter electrically coupled to the stator winding. The generator is configured to generate a first electrical power at the stator winding and to generate or absorb a second electrical power at the rotor winding, and wherein a DC link between the rotor side converter and the line side converter is electrically coupled to photo-voltaic power source operable to supply a solar electrical power to the DC-link. The method further includes enabling operation of the engine at a second operating speed corresponding to a desired level of a second electrical power to be absorbed or generated at the rotor winding and a second desired level of the engine power in a second operating condition.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an electrical power distribution system having an engine, in accordance with aspects of the present specification;

FIG. 2 is a flowchart of an example method for operating a power generation system, in accordance with aspects of the present specification;

FIG. 3 is a flowchart of an example method for charging an energy storage device, in accordance with aspects of the present specification;

FIG. 4 is a flowchart of an example method for operating an engine in a low load mode, in accordance with aspects of the present specification;

FIG. 5 is a graphical representation of an example relationship between engine efficiency (E) and an operating speed (ω) for different values of engine power (P_{engine}), in accordance with aspects of the present specification;

FIG. 6 is a flowchart of an example method for operating an engine in an efficiency mode, in accordance with aspects of the present specification;

FIG. 7 is a flowchart of an example method for operating an engine in a low fuel consumption mode, in accordance with aspects of the present specification;

FIG. 8 is a flowchart of an example method for curtailing solar electrical power, in accordance with aspects of the present specification;

FIG. 9 is a flowchart of an example method for operating an engine to control emissions, in accordance with aspects of the present specification; and

FIG. 10 is a flowchart of an example method for operating an engine in a way to enhance a useful life of the engine, in accordance with aspects of the present specification.

### DETAILED DESCRIPTION

The specification may be best understood with reference to the detailed figures and description set forth herein. Various embodiments are described hereinafter with reference to the figures. However, those skilled in the art will readily appreciate that the detailed description given herein with respect to these figures is for explanatory purposes as the method and the system may extend beyond the described embodiments.

In the following specification, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

In accordance with some aspects of the present specification, a power generation system is disclosed. The power generation system includes an engine operable at variable speeds. The power generation system further includes a doubly-fed induction generator (DFIG) mechanically coupled to the engine. The DFIG includes a generator having a rotor winding and a stator winding, a rotor side converter electrically coupled to the rotor winding, and a line side converter electrically coupled to the stator winding. The generator is configured to generate a first electrical power at the stator winding and to generate or absorb a second electrical power at the rotor winding. Furthermore, the power generation system includes photo-voltaic power source electrically coupled to a direct-current (DC) link between the rotor side converter and the line side converter, wherein the photo-voltaic power source is configured to supply a solar electrical power to the DC-link. The power generation system also includes a controller operatively coupled to the engine, the rotor side converter, and the line side converter. The controller is configured to operate the engine at a first operating speed corresponding to a first determined efficiency of the engine for a first desired level of an engine power in a first operating condition; or operate the engine at a second operating speed corresponding to a desired level of the second electrical power that is to be absorbed or generated by the rotor winding and a second desired level of the engine power in a second operating condition, wherein the first determined efficiency is substantially close to a maximum achievable efficiency of the engine. A method of operating the power generation system is also disclosed.

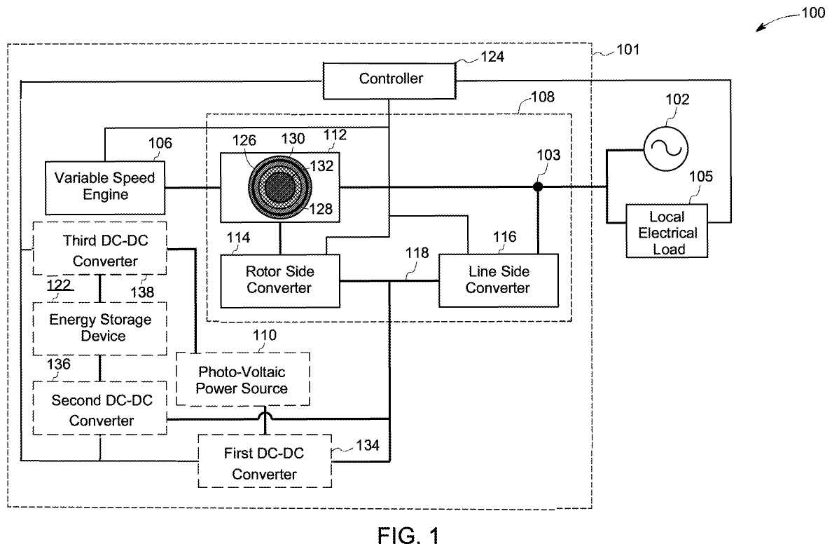

FIG. 1 is a block diagram of an electrical power distribution system 100, in accordance with aspects of the present specification. The electrical power distribution system 100 may include a power generation system 101 coupled to an electric grid 102 at a point of common coupling (PCC) 103. In some embodiments, the power generation system 101 may be coupled to the PCC 103 via a transformer (not shown in FIG. 1). In some embodiments, the PCC 103 may be coupled to a local electrical load 105 to enable supply of an alternating-current (AC) power to the local electrical load 105.

The electric grid 102 (e.g., utility electricity grid) may be representative of an interconnected network for delivering a grid power (e.g., electricity) from one or more power generation stations (different from the power generation system 101) to consumers (e.g., the local electrical load 105) through high/medium voltage transmission lines. The grid power may be received at the PCC 103 from the electric grid 102. The local electrical load 105 coupled to the PCC 103 may include electrical devices that are operable using the electric power received from the electric grid 102 or the power generation system 101.

In some embodiments, the power generation system 101 may function as a micro-grid or mini-grid. The term “micro-grid,” as used herein refers to a power generation and supply system that is capable of generating and supplying electrical power of less than 10 kW. The term “mini-grid,” as used herein refers to a power generation and supply system that is capable of generating and supplying electrical power of 10 kW and above.

In some embodiments, the power generation system 101 may include one or more engines, such as an engine 106, which are operable at variable speeds, a doubly-fed induction generator (DFIG) 108, at least one of a photo-voltaic (PV) power source 110, and an energy storage device 122. In some embodiments, the power generation system 101 may also include a controller 124 operatively coupled to at least one of the engine 106 and the DFIG 108. The controller 124 may be configured to control the operations of the engine 106 and the DFIG 108. In some embodiments, the DFIG 108 may include one or more of a generator 112, a rotor side converter 114, and a line side converter 116.

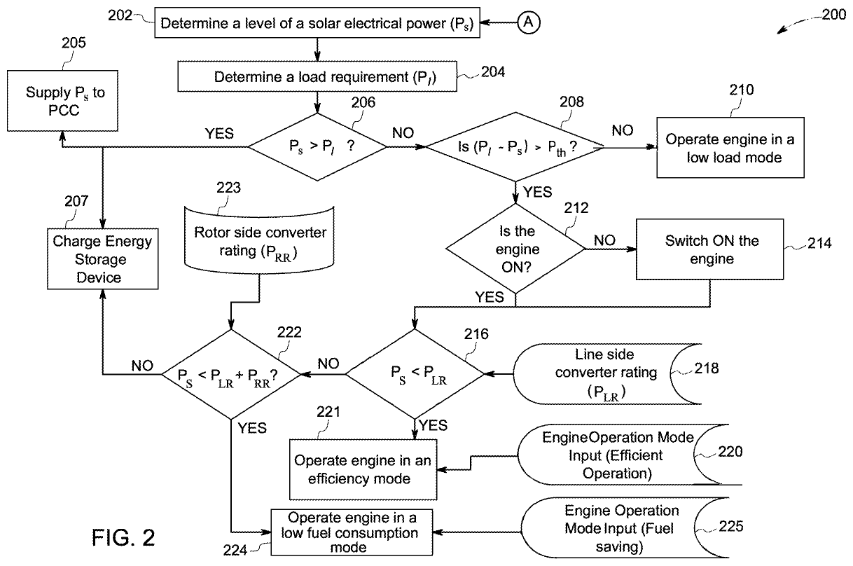

In one embodiment, the controller 124 may include a specially programmed general purpose computer, a microprocessor, a digital signal processor, and/or a microcontroller. The controller 124 may also include input/output ports, and a storage medium, such as, an electronic memory. Various examples of the microprocessor include, but are not limited to, a reduced instruction set computing (RISC) architecture type microprocessor or a complex instruction set computing (CISC) architecture type microprocessor. Further, the microprocessor may be a single-core type or multi-core type. Alternatively, the controller 124 may be implemented as hardware elements such as circuit boards with processors or as software running on a processor such as a commercial, off-the-shelf personal computer (PC), or a microcontroller. In certain embodiments, the engine 106, the rotor side converter 114, and the line side converter 116 may include controllers/control units/electronics to control their respective operations under a supervisory control of the controller 124. The controller 124 may be capable of executing program instructions for controlling operations of the power generation system 101, the electrical devices constituting the local electrical load 105. In some embodiments, the controller 124 may aid in executing methods described in FIGS. 2-4 and 6-10.

The engine 106 may refer to any system that may aid in imparting a controlled rotational motion to rotary element(s) (e.g., a rotor) of the generator 112. For example, the engine 106 may be an internal combustion engine, an operating speed of which may be varied by the controller 124. More particularly, the engine 106 may be a variable speed reciprocating engine, where the reciprocating motion of a piston is translated into a rotational speed of a crank shaft connected thereto. The engine 106 may be operated by combustion of various fuels including, but not limited to, diesel, natural gas, petrol, liquefied petroleum gas (LPG), biogas, biogas, producer gas, and the like. The engine 106 may also be operated using waste heat cycle. It is to be noted that the scope of the present specification is not limited with respect to the types of fuel and the engine 106 employed in the power generation system 101.

The DFIG 108 may include the generator 112. In a non-limiting example, the generator 112 may be a wound rotor induction generator. The generator 112 may include a stator 126, a rotor 128, a stator winding 130 disposed on the stator 126, and a rotor winding 132 disposed on the rotor 128. The generator 112 may be electrically coupled to the PCC 103. More particularly, the stator winding 130 may be coupled (directly or indirectly) to the PCC 103.

In some embodiments, a turn's ratio of the rotor winding 132 and the stator winding 130 may be selected such that the generator 112 may be operable at substantially wide range of operating speeds both in case of sub-synchronous and super-synchronous modes. In some embodiments, a turns ratio of the rotor winding 132 and the stator winding 130 may also limit a boost capacity of the rotor side converter 114 under the super-synchronous mode, particularly when leakage inductance of rotor winding 132 is utilized. For example, a unity turns ratio may enable a generator having 6 poles to run up to about 2000 RPM without exceeding a rotor side voltage rating. In some embodiments, the generator 112 may be required to operate in the super-synchronous mode. In a non-limiting example, a base line operating speed of the engine 106 may be maintained at about 1000 RPM to facilitate operation of the generator 112 in the super-synchronous mode. Such operation of the generator 112 at the base line operating speed of 1000 RPM may require the turns ratio of the rotor winding 132 and the stator winding 130 to be unity to facilitate wide variation in the operating speed above the base operating speed, for example 100%.

The DFIG 108 may be mechanically coupled to the engine 106. In some embodiments, the rotor 128 of the generator 112 may be mechanically coupled to the crank shaft of the engine 106, such that during operation rotations of the crank shaft may cause a rotary motion of the rotor 128 of the generator 112, and vice versa. In some embodiments, the crank shaft of the engine 106 may be coupled to the rotor 128 of the generator 112 through one or more gears. In operation, the generator 112 may be configured to generate a first electrical power (Pₛₜₐₜₒᵣ) at the stator winding 130 and to generate or absorb a second electrical power (Pᵣₒₜₒᵣ) at the rotor winding 132 depending on an operating speed (ω) of the engine 106.

In some embodiments, the DFIG 108 may further include the rotor side converter 114 and the line side converter 116. Each of the rotor side converter 114 and the line side converter 116 may act as an AC-DC converter or a DC-AC converter, and may be controlled by the controller 124. The rotor side converter 114 may be electrically coupled to the rotor winding 132. Further, the line side converter 116 may be electrically coupled to the stator winding 130 at the PCC 103. The line side converter 116 may further be coupled to the PCC 103, directly or via a transformer (not shown in FIG. 1). In one embodiment, the rotor side converter 114 and the line side converter 116 are also coupled to each other. For example, the rotor side converter 114 and the line side converter 116 are electrically coupled to each other via a direct-current (DC) link 118.

Further, the power generation system 101 may include at least one of the PV power source 110 and the energy storage device 122 electrically coupled to the DFIG 108 at the DC-link 118. The PV power source 110 may include one or more PV arrays (not shown in FIG. 1), where each PV array may include at least one PV module (not shown in FIG. 1). A PV module may include a suitable arrangement of a plurality of PV cells (diodes and/or transistors). The PV power source 110 may generate a DC voltage constituting a solar electrical power (Pₛ) that depends on solar insolation, weather conditions, and/or time of the day. Accordingly, the PV power source 110 may be configured to supply the solar electrical power (Pₛ) to the DC-link 118.

In some embodiments, the PV power source 110 may be electrically coupled to the DFIG 108 at the DC-link 118 via a first DC-DC converter 134. The first DC-DC converter 134 may be electrically coupled between the PV power source 110 and the DC-link 118. In such embodiments, the solar electrical power (Pₛ) may be supplied from the PV power source 110 to the DC-link 118 via the first DC-DC converter 134. The first DC-DC converter 134 may be operated as a buck converter, a boost converter, or a buck-boost converter, and may be controlled by the controller 124.

The energy storage device 122 may include arrangements employing one or more batteries, capacitors, and the like. In some embodiments, the energy storage device 122 may be electrically coupled to the DFIG 108 at the DC-link 118 to supply a third electrical power to the DC-link 118. A maximum amount of the third electrical power that can be supplied by the energy storage device 122 may be referred to as “energy storage device rating.”

In some embodiments, the energy storage device 122 may be electrically coupled to the DFIG 108 at the DC-link 118 via a second DC-DC converter 136. The second DC-DC converter 136 may be electrically coupled between the energy storage device 122 and the DC-link 118. In such embodiments, the third electrical power may be supplied from the energy storage device 122 to the DC-link 118 via the second DC-DC converter 136. The second DC-DC converter 136 may be operated as a buck converter, a boost converter, or a buck-boost converter, and may be controlled by of the controller 124.

In some embodiments, the power generation system 101 may also include a third DC-DC converter 138. The third DC-DC converter 138 may be electrically coupled between the energy storage device 122 and the PV power source 110. In some embodiments, the third DC-DC converter 138 may be configured to charge the energy storage device 122 via the PV power source 110. For example, in some embodiments, the energy storage device 122 may receive a charging current via the third DC-DC converter 138 from the PV power source 110. The third DC-DC converter 138 may be operated as a buck converter, a boost converter, or a buck-boost converter, and may be controlled by the controller 124.

In some embodiments, in addition to being operatively coupled to the engine 106, the generator 112, the rotor side converter 114, and the line side converter 116, the controller 124 may be operatively coupled to at least one of the first DC-DC converter 134, the second DC-DC converter 136, and the third DC-DC converter 138 to control their respective operations. Furthermore, in some embodiments, the controller 124 may also be operatively coupled (as shown using dashed connector) to the local electrical load 105 to selectively connect and disconnect the respective electrical device to manage load.

As previously noted, the controller 124 may aid in executing a method for operating the power generation system 101 (see FIG. 2). In some embodiments, the controller 124 may aid in executing blocks of methods illustrated in flowcharts of FIGS. 2-4 and 6-10. In order to execute the blocks of these methods, the controller 124 may be configured to control the operation of one or more of the generator 112, the rotor side converter 114, the line side converter 116, the first DC-DC converter 134, the second DC-DC converter 136, and/or the engine 106. By way of example, the controller 124 may control the rotor side converter 114, the line side converter 116, the first DC-DC converter 134, and/or the second DC-DC converter 136 to facilitate a flow of the power through one or more of them in a determined direction to aid in cranking of the engine 106.

FIG. 2 is a flowchart 200 of an example method for operating the power generation system 101, in accordance with aspects of the present specification. The flowchart 200 is explained in conjunction with FIG. 1.

At block 202, the controller 124 may be configured to determine a level of solar electrical power (Pₛ) (kW) generated by the PV power source 110. In some embodiments, the controller 124 may be configured to estimate a level of the solar electrical power based on parameters including, but not limited to, solar insolation, weather conditions, and/or time of day. In some embodiments, additionally or alternatively, a sub-controller associated with the PV power source 110 may be configured to estimate a level of the solar electrical power based on parameters including, but not limited to, solar insolation, weather conditions, and/or time of day and subsequently communicate the estimated solar electrical power to the controller 124. Subsequently or parallel to the block 202, the controller 124, at block 204, may be configured to determine a load requirement (Pₗ) (kW) based on a demand of power at the PCC 103 from the local electrical load 105. In some embodiments, the controller 124 may also be configured to estimate the load requirement (Pₗ) based on a predefined usage pattern for a given duration of time.

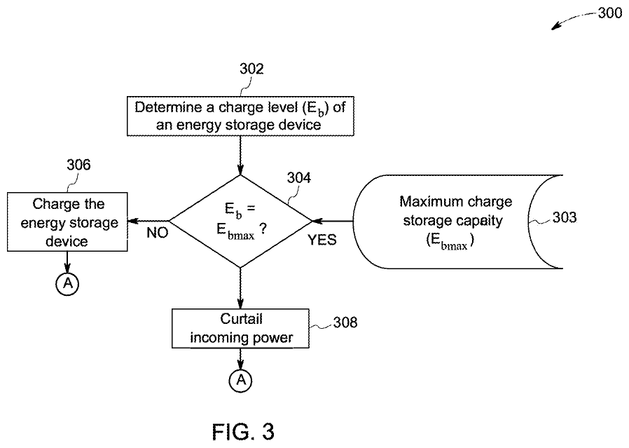

Subsequently, the controller 124 may perform a check at block 206 to determine whether the solar electrical power (Pₛ) is greater than the load requirement (Pₗ). If, at block 206, it is determined that the solar electrical power (Pₛ) is greater than the load requirement (Pₗ), the controller 124, at block 205, may be configured to supply the solar electrical power (Pₛ) to the PCC 103 to meet the load requirement (Pₗ). In some embodiments, as the solar electrical power (Pₛ) is greater than the load requirement (Pₗ), it may not be required to operate the engine 106. Further, if the load requirement (Pₗ) is lower than a rated power (P_{LR}) of the line side converter 116, the controller 124 may enable a flow of the solar electrical power (Pₛ) via the line side converter 116 to the PCC 103. In some embodiments, when the engine 106 is not operational and the load requirement (Pₗ) is greater than the rated power (P_{LR}) of the line side converter 116, the controller 124 may enable a flow of the solar electrical power (Pₛ) that is in excess of the rated power (P_{LR}), via the rotor side converter 114 to the rotor winding 132. Because of a transformer action of the generator 112, this power from the rotor winding 132 may be transferred to the stator winding 130 and to the PCC 103 from the stator winding 130. Further, as the solar electrical power (Pₛ) is greater than the load requirement (Pₗ), the controller 124, may also enable charging of the energy storage device 122 at block 207, in some embodiments. Details of charging of the energy storage device 122 are described in conjunction with FIG. 3.

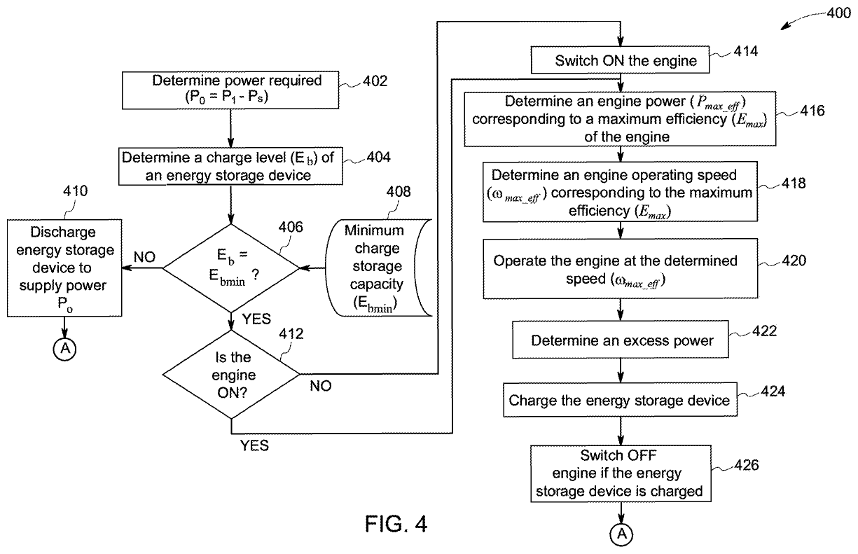

If, at block 206, it is determined that the solar electrical power (Pₛ) is lower than the load requirement (Pₗ), the controller 124 may be configured to perform another check, at block 208, to determine whether the solar electrical power (Pₛ) is substantially higher than the load requirement (Pₗ) or not. More particularly, at block 208, the controller 124 may be configured to perform another check to determine whether a difference between the load requirement (Pₗ) and the solar electrical power (Pₛ) is greater than a threshold value (Pₜₕ). If, at block 208, it is determined that the difference between the load requirement (Pₗ) and the solar electrical power (Pₛ) is lower than the threshold value (Pₜₕ), the controller 124 may be configured to operate the engine 106 in a low load mode at block 210. Details of operating the engine 106 in a low load mode are described in conjunction with FIG. 4.

Alternatively, if, at block 208, it is determined that the difference between the load requirement (Pₗ) and the solar electrical power (Pₛ) is greater than the threshold value, the controller 124, at block 212, may be configured to perform another check to determine whether the engine 106 is in an active state or an inactive state, where the active state refers to an ON state (operating state) of the engine and an inactive state refers to an OFF state (non-operating state) of the engine. If, at block 212, it is determined that the engine 106 is in the OFF state, the controller 124 may be configured to initiate cranking of the engine 106 at block 214.

In some embodiments, the controller 124 may be configured to operate the engine 106 in an efficiency mode in a first operating condition. By way of example, in the efficiency mode, the controller 124 may be configured to operate the engine 106 at a first operating speed (ω₁) corresponding to a first determined efficiency (E_{det1}) of the engine 106 for a first desired level of an engine power (P1_{engine}). In a non-limiting example, the first determined efficiency (E_{det1}) may be substantially close to a first maximum achievable efficiency (E_{max_P1}) of the engine 106 for the first desired level of an engine power (P1_{engine}).

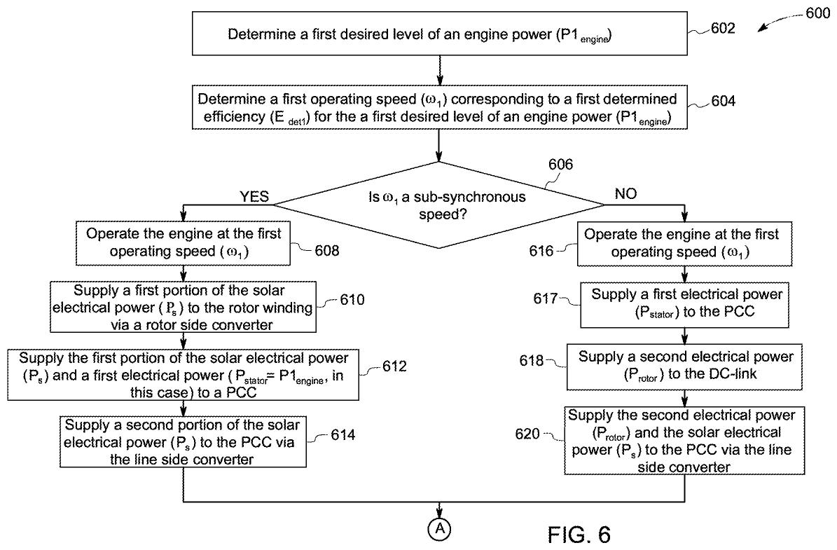

In one embodiment, the first operating condition may be defined as a condition where the solar electrical power (Pₛ) is lower than a rated power of the line side converter (P_{LR}). Accordingly, at block 212, if it is determined that the engine 106 is in the ON state, the controller 124 may be configured to perform another check, at block 216, to determine whether the solar electrical power (Pₛ) is less than the line side converter rating (P_{LR}). The line side converter rating (P_{LR}) may be an input 218 to the controller 124. In some embodiments, the line side converter rating (P_{LR}) may be stored in a memory associated with the controller 124. The controller 124 may be configured to retrieve the line side converter rating (P_{LR}) from the memory. In one embodiment, at block 216, if it is determined that the solar electrical power (Pₛ) is less than the line side converter rating (P_{LR}) the controller 124 may be configured to operate the engine 106 in the efficiency mode at block 221. In another embodiment, the first operating condition may include an efficiency mode is enabled. For example, a manual or an automated input such as an efficient mode operation input 220 may be received by the controller 124 demanding an efficient operation of the engine 106. In yet another embodiment, the first operating condition may include a pre-defined efficiency mode. For example, in some instances, the engine 106 may be pre-configured to operate in the efficiency mode. In such a situation, the controller 124 may be configured to operate the engine 106 in the efficiency mode. Details of operating the engine 106 in the efficiency mode (block 221) are described in conjunction with FIG. 6.

In some embodiments, the controller 124 may be configured to operate the engine 106 in a low fuel consumption mode in a second operating condition. By way of example, in the low fuel consumption mode, the controller 124 may be configured to operate the engine 106 at a second operating speed (ω₁) corresponding to a desired level of the second electrical power (Pᵣₒₜₒᵣ) that is to be absorbed by the rotor winding 132 and a second desired level of the engine power (P2_{engine}).

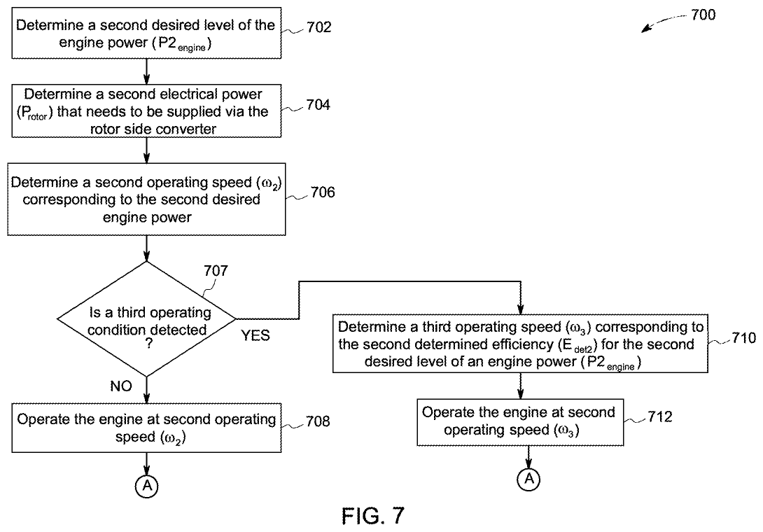

In one embodiment, the second operating condition may include the solar electrical power (Pₛ) is greater than the rated power of the line side converter (P_{LR}) and lower than a sum of the rated power of the line side converter (P_{LR}) and a rated power of the rotor side converter (P_{RR}). Accordingly, at block 216, if it is determined that the solar electrical power (Pₛ) is greater than the rated power of the line side converter (P_{LR}), the controller 124 may be configured to perform another check, at block 222, to determine whether the solar electrical power (Pₛ) is lower than the sum of the rated power of the line side converter (P_{LR}) and the rated power of the rotor side converter (P_{RR}). The rated power of rotor side converter (P_{RR}) may be an input 223 to the controller 124. In some embodiments, the rated power of the rotor side converter (P_{RR}) may be stored in a memory associated with the controller 124 and the controller 124 may be configured to retrieve the rated power of the rotor side converter (P_{RR}) from the memory. In one embodiment, at block 222, if it is determined that the solar electrical power (Pₛ) is less than the sum of the rated power of the line side converter (P_{LR}) and the rated power of the rotor side converter (P_{RR}), the controller 124 may be configured to operate the engine 106 in the low fuel consumption mode at block 224. In another embodiment, the second operating condition may include the low fuel consumption mode is enabled. For example, a manual or an automated input such as a low fuel consumption mode input 225 may be received by the controller 124 for requesting fuel saving by the engine 106. In yet another embodiment, the second operating condition may include a pre-defined low fuel consumption mode. For example, in some instances, the engine 106 may be pre-configured to operate in the low fuel consumption mode. In these instances, the controller 124 may be configured to operate the engine 106 in the low fuel consumption mode. Details of operating the engine 106 in the low fuel consumption mode (block 224) are described in conjunction with FIG. 7.

In some instances when the solar electrical power (Pₛ) generated by the PV power source 110 is zero or substantially close to zero, to facilitate supply of power to the PCC 103 for a given load requirement (Pₗ), if the engine 106 needs to be operated at operating speeds lower than a threshold speed limit, the controller 124 may be configured to operate the engine 106 at a maximum possible efficiency corresponding to the given load requirement (Pₗ).

FIG. 3 is a flowchart 300 of an example method for charging the energy storage device 122, in accordance with aspects of the present specification. The flowchart 300 is explained in conjunction with FIG. 1. In some embodiments, blocks of the flowchart 300 are representative of sub-blocks of the block 207 (see FIG. 2) for enabling charging of the energy storage device 122.

At block 302, the controller 124 may be configured to determine a charge level (E_{b}) of the energy storage device 122. Further, at block 304, the controller 124 may be configured to determine whether the charge level (E_{b}) of the energy storage device 122 is similar to a maximum charge storage capacity (E_{bmax}) of the energy storage device 122. The maximum charge storage capacity (E_{bmax}) may be an input 303 to the controller 124. In some embodiments, the maximum charge storage capacity (E_{bmax}) may be stored in a memory associated with the controller 124 and the controller 124 may be configured to retrieve the maximum charge storage capacity (E_{bmax}) from the memory.

At block 304, if it is determined that the instantaneous charge level (E_{b}) of the energy storage device 122 is not similar to the maximum charge storage capacity (E_{bmax}) of the energy storage device 122, the controller 124 may be configured to charge the energy storage device 122, at block 306. In some embodiments, in order to charge the energy storage device 122, the controller 124 may be configured to operate the second DC-DC converter 136 to supply the DC power from the DC-link 118 to the energy storage device 122. In some embodiments, while the energy storage device 122 is charged via the DC power from the DC-link 118, the controller 124 may be configured to monitor the DC power level (or a DC voltage level) on the DC-link 118. If the DC-power level (or the DC voltage level) on the DC-link 118 begins to drop at a pre-defined rate, the controller 124 may conclude that there may be no excess power from the PV power source 110 to charge the energy storage device 122. Accordingly, in such a situation charging of the energy storage device 122 may be at least temporarily paused by the controller 124. In some embodiments, if a level of the solar electrical power (Pₛ) increases beyond a level determined by a maximum power point tracking technique, the controller 124 may enable the PV power source 110 to supply the solar electrical power (Pₛ) to the DC-link 118 via the second DC-DC converter 136, and charging of the energy storage device 122 may be re-initiated.

In some embodiments, in order to charge the energy storage device 122, the controller 124 may be configured to operate the third DC-DC converter 138 to supply the solar electrical power (Pₛ) from the PV power source 110 to the energy storage device 122. Once the function at block 306 is performed, the controller 124 may proceed to proceed to block 202 as illustrated in FIG. 2.

However, at block 304, if it is determined that the instantaneous charge level (E_{b}) of the energy storage device 122 is similar to a maximum charge storage capacity (E_{bmax}) of the energy storage device 122, the controller 124, at block 308, may conclude that the energy storage device 122 is fully charged and curtail any incoming power. By way of example, the DC power from the DC-link 118 or the solar electrical power (Pₛ) from the PV power source 110. Once the operation at block 308 is performed, the controller 124 may proceed to perform the block 202 as illustrated in FIG. 2.

FIG. 4 is a flowchart 400 of an example method for operating the engine 106 in the low load mode, in accordance with aspects of the present specification. The flowchart 400 is explained in conjunction with FIG. 1. In some embodiments, blocks of the flowchart 400 are representative of sub-blocks of the block 210 (see FIG. 2) for operating the engine 106 in the low load mode. As previously noted, the controller 124 is configured to operate the engine 106 in the low load mode if the load requirement (Pₗ) is not substantially higher than the solar electrical power (Pₛ), more particularly, when the difference between the solar electrical power (Pₛ) and the load requirement (Pₗ) is lower than the threshold value (Pₜₕ). In an embodiment, in this mode of operation, since the load requirement (Pₗ) is not substantially higher than the solar electrical power (Pₛ), operating of the engine 106 may be avoided till a power (i.e., the third electrical power) from the energy storage device 122 is sufficient to meet the load requirement (Pₗ) along with the available the solar electrical power (Pₛ).

At block 402, the controller 124 may be configured to determine a power required (Pₒ) to meet the load requirement (Pₗ) of the local electrical load 105. In some embodiments, the power required (Pₒ) may be determined using relationship represented by Equation (1) below:

Pₒ=Pₗ−Pₛ Equation (1)

Furthermore, at block 404, the controller 124 may be configured to determine the charge level (E_{b}) of the energy storage device 122. Moreover, at block 406, the controller 124 may be configured to perform another check to determine whether the instantaneous charge level (E_{b}) of the energy storage device 122 is similar to a minimum charge storage capacity (E_{bmin}) of the energy storage device 122. By way of example, at block 406 the check may be performed to determine whether the energy storage device 122 is exhausted. The minimum charge storage capacity (E_{bmin}) of the energy storage device 122 may be an input 408 to the controller 124. In some embodiments, a value of the minimum charge storage capacity (E_{bmin}) may be stored in a memory associated with the controller 124 and the controller 124 may be configured to retrieve the value of the minimum charge storage capacity (E_{bmin}) from the memory.

At block 406, if it is determined that the charge level (E_{b}) of the energy storage device 122 is not similar to a minimum charge storage capacity (E_{bmin}), the controller 124 may be configured to discharge the energy storage device 122 at block 410. More particularly, to discharge the energy storage device 122, the controller 124 may be configured to control the second DC-DC converter 136 such that the DC power from the energy storage device 122 is supplied to the DC-link 118. Once the block 410 is performed, the controller 124 may proceed to perform the block 202 as illustrated in FIG. 2.

However, at block 406, if it is determined that the charge level (E_{b}) of the energy storage device 122 is similar to a minimum charge storage capacity (E_{bmin}), the controller 124 may conclude that the energy storage device 122 has exhausted the stored energy and may perform another check at block 412. At block 412, the controller 124 may be configured to perform a check to determine whether the engine 106 is in an ON state (operating state). If, at block 412, it is determined that the engine 106 is in an OFF state, the controller 124 may be configured to switch on the engine 106 by initiating cranking of the engine 106 (block 414).

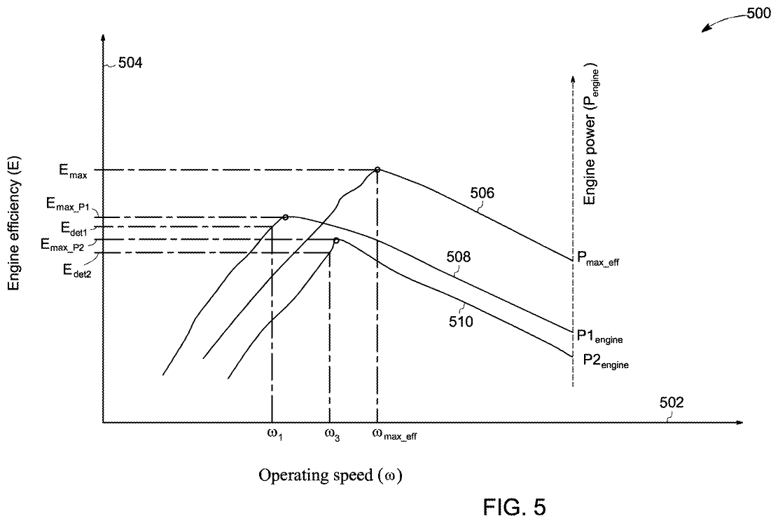

However, at block 412, if it is determined that the engine 106 is in an ON state, the controller 124 may be configured to determine an engine power (P_{max_eff}) at which the engine 106 may be operated at a maximum efficiency (Eₘₐₓ). In addition, the controller 124 may be configured to determine an operating speed (ω_{max_eff}) of the engine corresponding to the maximum efficiency (Eₘₐₓ). The controller 124 may be configured to determine the operating speed (ω_{max_eff}) based on an engine efficiency (E) and the operating speed (ω) characteristics of the engine 106 corresponding to the engine power (P_{engine}). One example relationship between the engine efficiency (E) and the operating speed (ω) is shown in FIG. 5.

FIG. 5 is a graphical representation 500 of an example relationship between engine efficiency (E) and the operating speed (ω) of the engine 106 for different values of engine power (P_{engine}), in accordance with aspects of the present specification. The graphical representation 500 is also referred to as engine efficiency (E) and the operating speed (ω) characteristics of the engine 106. The x-axis 502 of the graphical representation 500 represents the operating speed (ω) of the engine 106 in rpm and the y-axis 504 represents the engine efficiency (E) of the engine 106. Curves 506, 508, and 510 represent example relationship between the engine efficiency (E) and the operating speed (ω) for different values of the engine power (P_{engine}), for example, P_{max_eff}, P1_{engine}, and P2_{engine}, respectively. For ease of illustration, only three curves corresponding to three different engine power levels are shown FIG. 5. As depicted in FIG. 5, the engine power (P_{engine}) that corresponds to the maximum efficiency is P_{max_eff}. In some embodiments, electronic information corresponding to the engine efficiency (E) and the operating speed (ω) characteristics may be stored on the memory associated with the controller 124 as a look-up table. Referring again to FIG. 4, the controller 124 may be configured to determine the first operating speed (ω_{max_eff}) based on the look-up table.

Further, at block 420, the controller 124 may be configured to operate the engine 106 at the operating speed (ω_{max_eff}) to generate the power (P_{max_eff}). In some embodiments, the engine power (P_{engine}) corresponds to the first electrical power (Pₛₜₐₜₒᵣ) generated at the stator winding 130. Accordingly, when the engine 106 is operated the operating speed (ω_{max_eff}), the first electrical power (Pₛₜₐₜₒᵣ=P_{max_eff}) may be generated at the stator winding 130.

In some embodiments, the first electrical power (Pₛₜₐₜₒᵣ) thus generated may be greater than the load requirement (Pₗ). Accordingly, at block 422, the controller 124 may be configured to determine an excess power by subtracting the load requirement (Pₗ) from the first electrical power (Pₛₜₐₜₒᵣ). Further, at block 424, the controller 124 may be configured to enable charging of the energy storage device 122 using the excess power. Details of charging the energy storage device 122 are described in conjunction with FIG. 3. In some embodiments, once the energy storage device 122 is charged, the controller 124 may be configured to turn OFF the engine 106 at block 426. Once the engine is turned off at block 426 is performed, the controller 124 may proceed to perform the block 202 as illustrated in FIG. 2.

FIG. 6 is a flowchart 600 of an example method for operating the engine 106 in the efficiency mode, in accordance with aspects of the present specification. The flowchart 600 is explained in conjunction with FIG. 1. In some embodiments, blocks of the flowchart 600 are representative of sub-blocks of the block 221 (see FIG. 2) for operating the engine 106 in the efficiency mode. As previously noted, operation of the engine 106 in the efficiency mode may be triggered by various conditions including, but not limited to, the solar electrical power (Pₛ) is lower than a rated power of the line side converter (P_{LR}), the efficiency mode is enabled, or the pre-defined efficiency mode is set, or combinations thereof. In the efficiency mode, the controller 124 may be configured to operate the engine 106 at a first determined efficiency (E_{det1}) for a first desired level of the engine power (P1_{engine}). In some embodiments, the first determined efficiency (E_{det1}) is substantially close to a first maximum achievable efficiency (E_{max_P1}) corresponding to the first desired level of the engine power of the engine 106. In some embodiments, the term substantially close to the first maximum achievable efficiency (E_{max_P1}) refers to a value of the engine efficiency (E) in a range between the first maximum achievable efficiency (E_{max_P1}) and about 90% of the first maximum achievable efficiency (E_{max_P1}). In some embodiments, the term substantially close to the first maximum achievable efficiency (E_{max_P1}) refers to a value of the engine efficiency (E) in a range between the first maximum achievable efficiency (E_{max_P1}) and about 95% of the first maximum achievable efficiency (E_{max_P1}). In some embodiments, the term substantially close to the first maximum achievable efficiency (E_{max_P1}) refers to a value of the engine efficiency (E) in a range between the first maximum achievable efficiency (E_{max_P1}) and about 80% of the first maximum achievable efficiency (E_{max_P1}). In some embodiments, the first determined efficiency (E_{det1}) may be same as the first maximum achievable efficiency (E_{max_P1}) corresponding to the first desired level of the engine power (P1_{engine}) of the engine 106.

To operate the engine 106 in the efficiency mode, the controller 124 may be configured to determine the first desired level of the engine power (P1_{engine}) at block 602. The controller 124 may determine the first desired level of the engine power (P1_{engine}) based on the solar electrical power (Pₛ) generated by the PV power source 110 and the load requirement (Pₗ). For example, the first desired level of the engine power (P1_{engine}) may be represented by Equation (2) as below:

P1_{engine}=Pₗ−Pₛ Equation (2)

Further, at block 604, the controller 124 may be configured to determine the first operating speed (ω₁) corresponding to the first determined efficiency (E_{det1}) based on the efficiency (E) and speed (ω) characteristics (shown in FIG. 5) of the engine 106 corresponding to the first desired level of the engine power (P1_{engine}). The controller 124 may determine the first operating speed (ω₁) corresponding to the first determined efficiency (E_{det1}) based on the look-up table stored in the memory associated with the controller 124. The look-up table may be representative of the graphical relationship 500 depicted in FIG. 5.

Once the first operating speed (ω₁) is determined, the controller 124 may be configured to perform a check, at block 606, to determine whether the first operating speed (ω₁) is a sub-synchronous speed (e.g., a speed lower than a synchronous speed of the generator 112). At block 606, if it is determined that the first operating speed (ω₁) is sub-synchronous speed, the controller 124 is configured to operate the engine 106 at the first operating speed (ω₁) at block 608. Further, at block 610, the controller 124 may be configured to supply a first portion of the solar electrical power (Pₛ) to the rotor winding 132 via the rotor side converter 114. To supply the first portion of the solar electrical power (Pₛ) to the rotor winding 132, the controller 124 may be configured to operate the rotor side converter 114 as a DC-AC converter (i.e., an inverter). Furthermore, at block 612, the controller 124 may be configured to supply the first portion of the solar electrical power (Pₛ) and the first electrical power (Pₛₜₐₜₒᵣ P1_{engine}, in this case) to the PCC 103 via the stator winding 130. Moreover, at block 614, the controller 124 may be configured to supply a second portion of the solar electrical power (Pₛ) to the PCC 103 via the line side converter 116. To supply the second portion of the solar electrical power (Pₛ) to the PCC 103, the controller 124 may be configured to operate the line side converter 116 as a DC-AC converter (i.e., an inverter). Once the block 614 is performed, the controller 124 may proceed to perform the block 202 as illustrated in FIG. 2.

Referring again to block 606, if it is determined that the first operating speed (ω₁) is not a sub-synchronous speed, the controller 124 is configured to operate the engine 106 at the first operating speed (ω₁) at block 616. Accordingly, the generator 112 may generate electrical power at both the stator winding 130 (i.e., the first electrical power stator, P and the rotor winding 132 as the first operating speed (ω₁) is a super-synchronous speed. Electrical power generated at the rotor winding 132 is referred to as the second electrical power (Pᵣₒₜₒᵣ). Once the engine 106 is operated at the first operating speed (ω₁), the controller 124 is configured to supply the first electrical power (Pₛₜₐₜₒᵣ) to the PCC 103 at block 617. Further, at block 618, the controller 124 is configured to supply the second electrical power (Pᵣₒₜₒᵣ) to the DC-link 118. To supply the second electrical power (Pᵣₒₜₒᵣ) to the PCC 103, the controller 124 may be configured to operate the rotor side converter 114 as an AC-DC converter. In addition, at block 620, the second electrical power (Pᵣₒₜₒᵣ) and the solar electrical power (Pₛ) to the PCC 103 from the DC-link 118 via the line side converter 116. To supply the second electrical power (Pᵣₒₜₒᵣ) and the solar electrical power (Pₛ) may be provided to the PCC 103 from the DC-link 118 to the PCC 103, the controller 124 may be configured to operate the line side converter 116 as a DC-AC converter (i.e., an inverter). Once the block 614 is performed, the controller 124 may proceed to perform the block 202 as illustrated in FIG. 2.

FIG. 7 is a flowchart 700 of an example method for operating the engine 106 in a low fuel consumption mode, in accordance with aspects of the present specification. The flowchart 700 is explained in conjunction with FIG. 1. In some embodiments, blocks of the flowchart 700 are representative of sub-blocks of the block 224 (see FIG. 2) for operating the engine 106 in the low fuel consumption mode. As previously noted, operation of the engine 106 in the low fuel consumption mode may be triggered by various conditions including, but not limited to, the solar electrical power (Pₛ) is greater than a rated power of the line side converter (P_{LR}) but less than the sum of the rated power of the line side converter (P_{LR}) and the rated power of the rotor side converter (P_{RR}), the low fuel consumption mode is enabled, or the pre-defined low fuel consumption mode is set, or combinations thereof.

To operate the engine 106 in the low fuel consumption mode, the controller 124 may be configured to determine a second desired level of the engine power (P2_{engine}) at block 702. The controller 124 may determine the second desired level of the engine power (P2_{engine}) based on the solar electrical power (Pₛ) generated by the PV power source 110 and the load requirement (Pₗ). For example, the second desired level of the engine power (P2_{engine}) may be represented by Equation (3) as below:

P2_{engine}=Pₗ−Pₛ Equation (3)

At block 704, the controller 124 may be configured to determine the second electrical power (Pᵣₒₜₒᵣ) that needs to be supplied via the rotor side converter 114. The controller 124 may determine the second electrical power (Pᵣₒₜₒᵣ) based on the solar electrical power (Pₛ) and the line side converter (P_{LR}). For example, the second electrical power (Pᵣₒₜₒᵣ) may be represented by Equation (4) as below:

Pᵣₒₜₒᵣ=Pₛ−P_{LR} Equation (4)

Subsequently, at block 706, the controller 124 may be configured to determine a second operating speed (ω₂) corresponding to the second desired engine power (P2_{engine}). The second operating speed (ω₂) thus determined may correspond to low fuel consumption. In some embodiments, the controller 124 may determine the second operating speed (ω₂) based on a slip (S) of the generator. For example, the slip (S) may be represented by Equation (5) as below:

$$S = \frac{{P}_{rotor}}{{P}_{stotor} - {P}_{rotor}} \qquad Equation ( 5 )$$

where, Pₛₜₐₜₒᵣ=P2_{engine}, in the present situation.

Further, the second operating speed (ω₂) may be represented by Equation (6) as below:

$${ω}_{2} = \frac{{ω}_{s}}{S + 1} \qquad Equation ( 6 )$$

where ωₛ represents a synchronous speed of stator magnetic field.

Subsequently, in some embodiments, the controller 124 may be configured to perform a check at block 707 to determine whether a third operating condition is detected. For example, in certain instances, in the low fuel consumption mode, the engine 106 may operate the lower operating speeds leading to fuel savings. However, if the second operating speed (ω₂) at which the engine 106 is to be operated in the low fuel consumption mode is below a minimum permissible speed (ωₘᵢₙ), operating the engine 106 at such low speeds may cause damage the engine 106. Accordingly, in some embodiments, the third operating condition may include an event where the operating speed (ω₂) is lower than the minimum permissible speed (ωₘᵢₙ). In some embodiments, the third operating condition may be defined as a condition where the engine 106 is pre-configured to operate in a prescribed manner (see blocks 710 and 712), if the solar electrical power (Pₛ) is lower than the sum of the rated power of the line side converter (P_{LR}) and the rated power of the rotor side converter (P_{RR}).

If, at block 707, it is determined that the third operating condition is not detected, the controller 124 may be configured to operate the engine 106 at the second operating speed (ω₂) as indicated by block 708. Once the operation at block 614 is performed, the controller 124 may proceed to perform the operation at block 202 as illustrated in FIG. 2.

However, at block 707, if it is determined that the third operating condition exists, at block 710, the controller 124 may be configured to determine a third operating speed (ω₃) corresponding to a second determined efficiency (E_{det2}) for the second desired level of the engine power (P2_{engine}). In some embodiments, the controller may determine the third operating speed (ω₃) based on the efficiency (E) and speed (ω) characteristics (shown in FIG. 5) of the engine 106 corresponding to the second desired level of the engine power (P2_{engine}). The controller 124 may determine the third operating speed (ω₃) corresponding to the second determined efficiency (E_{det2}) based on the look-up table stored in the memory associated with the controller 124. The look-up table may be representative of the graphical relationship 500 depicted in FIG. 5. Further, in some embodiments, the second determined efficiency (E_{det2}) is substantially close to a second maximum achievable efficiency (E_{max_P2}) corresponding to the second desired level of the engine power of the engine 106. In some embodiments, substantially close to the second maximum achievable efficiency (E_{max_P2}) refers to a value of the engine efficiency (E) in a range between the second maximum achievable efficiency (E_{max_P2}) and about 90% of the second maximum achievable efficiency (E_{max_P2}). In some embodiments, the term substantially close to the second maximum achievable efficiency (E_{max_P2}) refers to a value of the engine efficiency (E) in a range between the second maximum achievable efficiency (E_{max_P2}) and about 95% of the second maximum achievable efficiency (E_{max_P2}). In some embodiments, the term substantially close to the second maximum achievable efficiency (E_{max_P2}) refers to a value of the engine efficiency (E) in a range between the second maximum achievable efficiency (E_{max_P2}) and about 80% of the second maximum achievable efficiency (E_{max_P2}). In some embodiments, the second determined efficiency (E_{det2}) may be same as the second maximum achievable efficiency (E_{max_P2}) corresponding to the second desired level of the engine power (P2_{engine}) of the engine 106. Once the third operating speed (ω₃) is determined, the controller 124 may be configured to operate the engine 106 at the third operating speed (ω₃) at block 712.

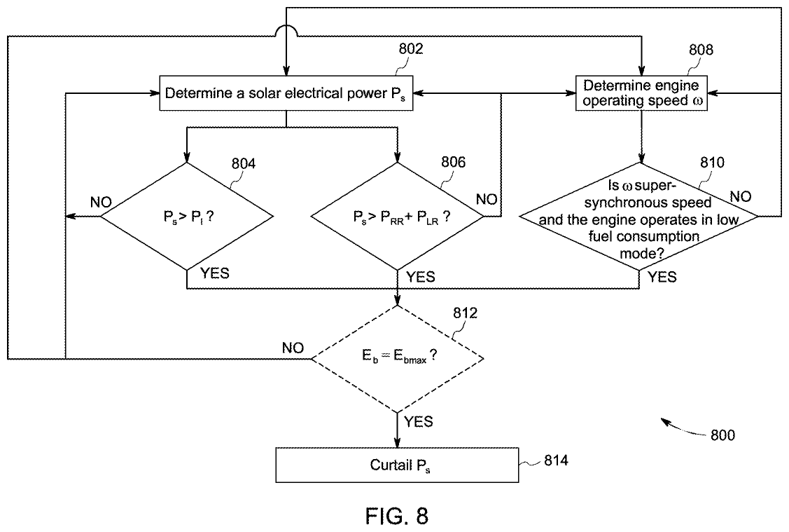

FIG. 8 is a flowchart 800 of an example method for curtailing the solar electrical power (Pₛ), in accordance with aspects of the present specification. In some embodiments, the method described in FIG. 8 may be executed in parallel with the method of FIG. 1. The flowchart 800 is explained in conjunction with FIG. 1.

At block 802, the controller 124 may be configured to determine the solar electrical power (Pₛ). As previously noted, the solar electrical power (Pₛ) may be determined by employing techniques described in block 202 of FIG. 2. Subsequently, in some embodiments, the controller 124 may be configured to perform a check at a block 804 to determine whether the solar electrical power (Pₛ) is greater than the load requirement (Pₗ). At block 804, if it is determined that the solar electrical power (Pₛ) is not greater than the load requirement (Pₗ), the controller 124 loops back to the block 802 and block 808 (described later). However, at block 804, if it is determined that the solar electrical power (Pₛ) is greater than the load requirement (Pₗ), the controller 124 may execute block 812 (described later). In some embodiments, when the energy storage device 122 is not present and at block 804, if it is determined that the solar electrical power (Pₛ) is greater than the load requirement (Pₗ), the controller 124 may directly execute block 814 (described later).

In some embodiments, once the solar electrical power (Pₛ) is determined, the controller 124 may be configured to perform a check at block 806 whether the solar electrical power (Pₛ) is greater than the sum of the rated power of the line side converter (P_{LR}) and a rated power of the rotor side converter (PR R). At block 806, if it is determined that the solar electrical power (Pₛ) is not greater than the sum of the rated power of the line side converter (P_{LR}) and a rated power of the rotor side converter (PR R), the controller 124 loops back to the block 802 and block 808 (described later). However, at block 806, if it is determined that the solar electrical power (Pₛ) is greater than the sum of the rated power of the line side converter (P_{LR}) and the rated power of the rotor side converter (P_{RR}), the controller 124 may execute block 812 (described later). In some embodiments, when the energy storage device 122 is not present and at block 806, if it is determined that the solar electrical power (Pₛ) is greater than the sum of the rated power of the line side converter (P_{LR}) and a rated power of the rotor side converter (PR R), the controller 124 may directly execute block 814 (described later).

At block 808, the controller 124 may be configured to determine an operating speed (ω) of the engine 106. By way of example, the controller 124 may determine the operating speed (ω) based on information received from a tachometer (not shown). In some embodiments, the controller 124 may be configured to estimate the operating speed (ω) one or more physics based models.

In some embodiments, at block 810, the controller 124 may be configured to perform a check to determine whether the operating speed (ω) determined at block 808 is super-synchronous and the engine 106 is operating in the low fuel consumption mode. At block 810, if it is determined that the operating speed (ω) determined at block 808 is not super-synchronous speed and the engine 106 is not operating in the low fuel consumption mode, the controller 124 loops back to the block 802 and block 808. However, at block 810, if it is determined that the operating speed (ω) determined at block 808 is super-synchronous speed and the engine 106 is operating in the low fuel consumption mode, the controller 124 may execute block 812. In some embodiments, when the energy storage device 122 is not present and at block 810, if it is determined that the operating speed (ω) determined at block 808 is super-synchronous speed and the engine 106 is operating in the low fuel consumption mode, the controller 124 may directly execute block 814 (described later).

Referring now to block 812, the controller 124 may be configured to perform another check to determine if a charge level (E_{b}) of the energy storage device 122 is similar to the maximum charge storage capacity (E_{bmax}) of the energy storage device 122 (i.e., determine whether the energy storage device 122 is fully charged). In some embodiments, the maximum charge storage capacity (E_{bmax}) may be stored in a memory associated with the controller 124 and the controller 124 may be configured to retrieve the maximum charge storage capacity (E_{bmax}) from the memory. At block 812, if it is determined that the instantaneous charge level (E_{b}) of the energy storage device 122 is not similar to the maximum charge storage capacity (E_{bmax}), the controller 124 loops back to the block 802 and block 808. However, at block 812, if it is determined that the instantaneous charge level (E_{b}) of the energy storage device 122 is similar to the maximum charge storage capacity (E_{bmax}), the controller 124 may be configured to curtail the solar electrical power (Pₛ) at block 814.

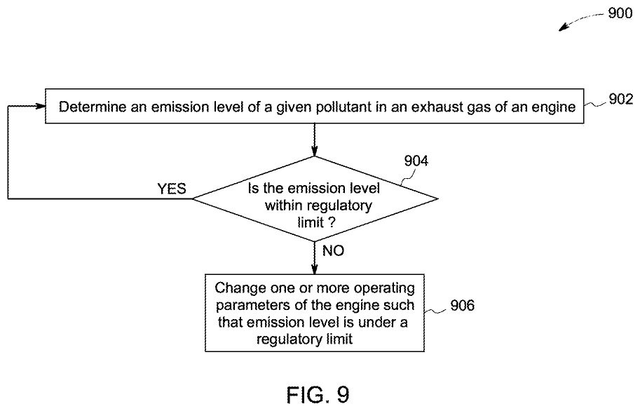

FIG. 9 is a flowchart 900 of an example method for operating the engine 106 to control emissions, in accordance with aspects of the present specification. In some embodiments, the method described in FIG. 9 may be executed in parallel with the method of FIG. 1. The flowchart 900 is explained in conjunction with FIG. 1.

In some embodiments, at block 902, the controller 124 may be configured to determine an emission level of a given pollutant in an exhaust gas of the engine 106. Examples of the pollutant may include, but are not limited to, carbon monoxide (CO), nitrogen oxide (NOx), particulate matter, or combinations thereof. In some embodiments, the controller 124 may determine the level of the pollutant via one or more sensors (not shown) disposed in a flow path of the exhaust gas in the engine 106. In some embodiments, the controller 124 may be configured to estimate the level of the pollutant using one or more physics based models.

Thereafter, at block 904, the controller 124 may be configured to perform a check to determine whether the emission level of the given pollutant is within a corresponding regulatory limit specified in emission norms of a given region. In some embodiments, the regulatory limit is stored in the memory associated with the controller 124. At block 904, if it is determined that the emission level of the given pollutant is not within the corresponding regulatory limit, the controller 124, at block 906, may be configured to change one or more operating parameters of the engine 106 such that emission level is under the corresponding regulatory limit. Non-limiting examples of the operating parameters may include an air-fuel ratio, fuel injection timing, flame temperature, and combinations thereof.

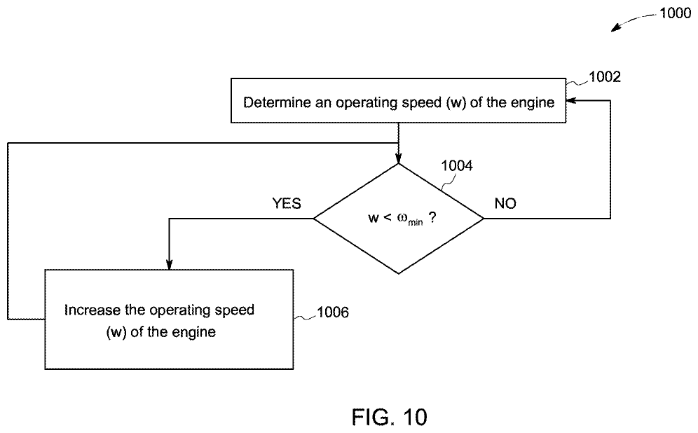

FIG. 10 is a flowchart 1000 of an example method for operating the engine in a way to enhance a useful life of the engine 106, in accordance with aspects of the present specification. The term “useful life” as used herein may refer to a lifespan of the engine 106 during which the engine 106 operates meeting required emission norms. In some embodiments, the method described in FIG. 10 may be executed in parallel with the method of FIG. 1. The flowchart 1000 is explained in conjunction with FIG. 1.

In some embodiments, at block 1002, the controller 124 may be configured to determine an operating speed (ω) of the engine 106. By way of example, the controller 124 may determine the operating speed (ω) based on information received from a tachometer (not shown). In some embodiments, the controller 124 may be configured to estimate the operating speed (ω) using one or more physics based models.

Thereafter, at block 1004, the controller 124 may be configured to perform a check to determine whether the operating speed (ω) is lower than a minimum permissible speed (ωₘᵢₙ) of the engine 106. In some embodiments, a value of the minimum permissible speed (ωₘᵢₙ) may be stored in the memory associated with the controller 124 (or an engine controller integrated with the engine 106 not shown). At block 1004, if it is determined that the operating speed (ω) is lower than the minimum permissible speed (ωₘᵢₙ), the controller 124, at block 1006, may be configured to increase the operating speed (ω) such that the operating speed (ω) is higher than the minimum permissible speed (ωₘᵢₙ).

Any of the foregoing blocks and/or system elements may be suitably replaced, reordered, or removed, and additional blocks and/or system elements may be inserted, depending on the needs of a particular application, and that the systems of the foregoing embodiments may be implemented using a wide variety of suitable processes and system elements and are not limited to any particular computer hardware, software, middleware, firmware, microcode, etc.

Furthermore, the foregoing examples, demonstrations, and method blocks such as those that may be performed by the controller 124 may be implemented by suitable code on a processor-based system, such as a general-purpose or special-purpose computer. Different implementations of the systems and methods may perform some or all of the blocks described herein in different orders, parallel, or substantially concurrently. Furthermore, the functions may be implemented in a variety of programming languages, including but not limited to C++ or Java. Such code may be stored or adapted for storage on one or more tangible or non-transitory computer readable media, such as on data repository chips, local or remote hard disks, optical disks (that is, CDs or DVDs), memory or other media, which may be accessed by a processor-based system to execute the stored code. Note that the tangible media may include paper or another suitable medium upon which the instructions are printed. For instance, the instructions may be electronically captured via optical scanning of the paper or other medium, then compiled, interpreted or otherwise processed in a suitable manner if necessary, and then stored in the data repository or memory.

In accordance with some embodiments of the present specification, the engine 106 may be operated in a low fuel consumption mode causing fuel saving. Such reduced fuel consumption helps achieve greener environment. In some embodiments, the engine 106 may be operated at higher efficiency (closer to maximum efficiency) for a given power level. Moreover, in some embodiments, the engine 106 may be operated at the maximum achievable efficiency. Also, in some embodiments, the power generation system 100 may be operated such that power from the energy storage device 122 is utilized to meet the load requirement in case of low load requirement. Consequently, use of the engine 106 may be avoided in case of the low load mode. This also results in additional fuel savings. In addition, by restricting the operation of the engine 106 at speeds below the minimum permissible speed, the useful life of the engine may be improved.

The present specification has been described in terms of some specific embodiments. They are intended for illustration only, and should not be construed as being limiting in any way. Thus, it should be understood that modifications can be made thereto, which are within the scope of the present specification and the appended claims.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art and are also intended to be encompassed by the following claims.

1. A power generation system, comprising:
an engine operable at variable speeds;
a doubly-fed induction generator (DFIG) mechanically coupled to the engine and comprising: a generator having a rotor winding and a stator winding, a rotor side converter electrically coupled to the rotor winding, and a line side converter electrically coupled to the stator winding, wherein the generator is configured to generate a first electrical power at the stator winding and to generate or absorb a second electrical power at the rotor winding;
a photo-voltaic power source electrically coupled to a direct-current (DC) link between the rotor side converter and the line side converter, wherein the photo-voltaic power source is configured to supply an solar electrical power to the DC-link; and
a controller operatively coupled to the engine, the rotor side converter, and the line side converter and configured to:
enable operation of the engine at a first operating speed corresponding to a first determined efficiency of the engine for a first desired level of an engine power in a first operating condition, wherein the first determined efficiency is substantially close to a first maximum achievable efficiency of the engine; or
enabling operation of the engine at a second operating speed corresponding to a desired level of the second electrical power to be generated or to be absorbed by the rotor winding and a second desired level of the engine power in a second operating condition.

2. The power generation system of claim 1, wherein the first operating condition comprises at least one of:
the solar electrical power is lower than a load requirement and a rated power of the line side converter,
an efficiency mode is enabled, or
a pre-defined efficiency mode is set.

3. The power generation system of claim 1, wherein the second operating condition comprises at least one of:
the solar electrical power is lower than a load requirement but greater than a rated power of the line side converter and lower than a sum of a rated power of the line side converter and a rated power of the rotor side converter,
a low fuel consumption mode is enabled, or
a pre-defined low fuel consumption mode is set.

4. The power generation system of claim 1, wherein, to operate the engine at the first operating speed, the controller is configured to determine the first desired level of the engine power based on a load requirement and a level of the solar electrical power.

5. The power generation system of claim 4, wherein the controller is further configured to:
determine the first operating speed corresponding to the first determined efficiency based on an efficiency and speed characteristics of the engine corresponding to the first desired level of the engine power; and
supply the second electrical power to the DC-link or absorb the second electrical power from the DC-link via the rotor side converter based on a slip of the generator.

6. The power generation system of claim 5, wherein the controller (124) is further configured to supply at least a portion of the solar electrical power to a point of common coupling (PCC) via the generator through the rotor side converter when the first operating speed is a sub-synchronous speed, wherein the PCC is electrically coupled to one or both of a local electrical load.

7. The power generation system of claim 6, wherein the controller is further configured to supply at least a portion of the solar electrical power and the second electrical power to the PCC via the line side converter when the first operating speed is a super-synchronous speed.

8. The power generation system of claim 1, wherein, in the second operating condition, to operate the engine at the second operating speed, the controller is configured to:
determine the second electrical power to be supplied to the rotor winding via the rotor side converter based on the solar electrical power and a sum of a rated power of the line side converter and a rated power of the rotor side converter;
determine the second desired engine power based on a load requirement and the solar electrical power;
determine the second operating speed corresponding to the determined second desired engine power and the determined second electrical power; and
operate the engine at the second operating speed.

9. The power generation system of claim 1, wherein, in the second operating condition, the controller is configured to:
determine the second desired engine power based on a load requirement and the solar electrical power;
determine a third operating speed corresponding to a second determined efficiency corresponding to the second desired engine power based on an efficiency and speed characteristics of the engine; and
operate the engine at the third operating speed.

10. The power generation system of claim 1, further comprising an energy storage device coupled to the DC-link.

11. The power generation system of claim 10, wherein the controller is further configured to enable charging of the energy storage device if:
the solar electrical power generated by the photo-voltaic power source is greater than a load requirement;
the solar electrical power is greater than a sum of a rated power of the line side converter and a rated power of the rotor side converter; or
the first electrical power generated at the stator winding is greater than a load requirement.

12. The power generation system of claim 10, wherein, if a load requirement is greater than the solar electrical power and a difference between the load requirement and the solar electrical power is less than a threshold value, the controller is configured to:
discharge the energy storage device to meet the load requirement; and
operate the engine at an operating speed corresponding to a maximum achievable efficiency once the energy storage device is discharged.

13. The power generation system of claim 10, wherein, the controller is further configured to curtail the solar electrical power if the energy storage device is charged and:
the solar electrical power is greater than a load requirement;
the solar electrical power is greater a sum of a rated power of the line side converter and a rated power of the rotor side converter; or
the engine is operating at a super-synchronous speed and the solar electrical power is greater than the rated power of the line side converter.

14. The power generation system of claim 1, wherein, the controller is further configured to curtail the solar electrical power if:
the solar electrical power is greater than a load requirement;
the solar electrical power is greater a sum of a rated power of the line side converter and a rated power of the rotor side converter; or
the engine is operating at a super-synchronous speed and the solar electrical power is greater than the rated power of the line side converter.

15. The power generation system of claim 1, wherein the controller is further configured to:
determine an emission level of a given pollutant in an exhaust gas emitted from the engine; and
adjust one or more operating parameters of the engine if the emission level is greater than a corresponding regulatory limit such that the emission level of the given pollutant is maintained within the corresponding regulatory limit.

16. The power generation system of claim 1, wherein the controller is further configured to:
determine an operating speed of the engine; and
increase the operating speed of the engine if the determined operating speed of the engine is less than a minimum permissible speed.

17. A method of operating a power generation system, comprising:
enabling operation of an engine at a first operating speed corresponding to a first determined efficiency of the engine for a first desired level of an engine power in a first operating condition, wherein the first determined efficiency is substantially close to a first maximum achievable efficiency of the engine, wherein the engine is mechanically coupled to a doubly-fed induction generator (DFIG) comprising a generator having a rotor winding and a stator winding, a rotor side converter electrically coupled to the rotor winding, and a line side converter electrically coupled to the stator winding (130), wherein the generator is configured to generate a first electrical power at the stator winding and to generate or absorb a second electrical power at the rotor winding, and wherein a direct-current (DC) link between the rotor side converter and the line side converter is electrically coupled to photo-voltaic power source operable to supply an solar electrical power to the DC-link; and
enabling operation of the engine at a second operating speed corresponding to a desired level of a second electrical power to be absorbed by the rotor winding and a second desired level of the engine power in a second operating condition.

18. The method of claim 17, wherein the first operating condition comprises at least one of:
the solar electrical power is lower than a rated power of the line side converter,
an efficiency mode is enabled, or
a pre-defined efficiency mode is set.

19. The method of claim 17, wherein the second operating condition comprises at least one of:
the solar electrical power is greater than a rated power of the line side converter and lower than a sum of a rated power of the line side converter and a rated power of the rotor side converter,
a low fuel consumption mode is enabled, or
a pre-defined low fuel consumption mode is set.

20. The method of claim 17, wherein in the first operating condition, further comprising:
determining the first desired level of the engine power based on a load requirement and a level of the solar electrical power;
determining the first operating speed corresponding to the first determined efficiency based on an efficiency and speed characteristics of the engine corresponding to the first desired level of the engine power; and
supplying the second electrical power to the DC-link or absorb the second electrical power from the DC-link via the rotor side converter based on a slip of the generator.

21. The method of claim 20, further comprising supplying at least a portion of the solar electrical power to a point of common coupling (PCC) via the generator through the rotor side converter when the first operating speed is a sub-synchronous speed.

22. The method of claim 20, further comprising supplying at least a portion of the solar electrical power and the second electrical power to a PCC via the line side converter (116) when the first operating speed is a super-synchronous speed.

23. The method of claim 17, wherein in the second operating condition, further comprising:
determining the second electrical power to be supplied to the rotor winding via the rotor side converter based on the solar electrical power and a sum of a rated power of the line side converter and a rated power of the rotor side converter;
determining the second desired engine power based on a load requirement and the solar electrical power;
determining the second operating speed corresponding to the determined second desired engine power and the determined the second electrical power; and
operating the engine at the second operating speed.

24. The method of claim 17, wherein in the second operating condition, further comprising:
determining the second desired engine power based on a load requirement and the solar electrical power;
determining a third operating speed corresponding to a second determined efficiency corresponding to the second desired level of the engine power based on an efficiency and speed characteristics of the engine; and
operating the engine at the third operating speed.

25. The method of claim 17, wherein the power generation system further comprises an energy storage device coupled to the DC-link, wherein the method further comprises enabling charging of the energy storage device if:
the solar electrical power generated by the photo-voltaic power source is greater than a load requirement;
the solar electrical power is greater than a sum of a rated power of the line side converter and a rated power of the rotor side converter; or
the first electrical power generated at the stator winding is greater than a load requirement.

26. The method of claim 17, wherein the power generation system further comprises an energy storage device coupled to the DC-link, wherein the method further comprises curtailing the solar electrical power if the energy storage device is charged and:
the solar electrical power is greater than a load requirement;
the solar electrical power is greater a sum of a rated power of the line side converter and a rated power of the rotor side converter;
the engine is operating at a super-synchronous speed and the solar electrical power is greater than the rated power of the line side converter; or
a third operating condition is detected.

27. The method of claim 17, wherein the power generation system further comprises an energy storage device coupled to the DC-link, wherein, if a load requirement is greater than the solar electrical power and a difference between the load requirement and the solar electrical power is less than a threshold value, the method further comprises:
discharging the energy storage device to meet the load requirement; and
operating the engine at an operating speed corresponding to a maximum achievable efficiency once the energy storage device is discharged.
